(19) United States
(12) Patent Application Publication
(10) Pub. No.: US 2018/0032318 A1
(43) Pub. Date: Feb. 1, 2018

(54) Methods and systems for rendering user interface based on user context and persona

(71) Applicant: Altimetrik Corp., Southfield, MI (US)

(72) Inventors: Madhavan Satagopan, Bangalore (IN); Aswath Premaradj, Bangalore (IN); Sriraman Raghunathan, Bangalore (IN); Himanshu Rai, Bangalore (IN)

(73) Assignee: Altimetrik Corp., Southfield, MI (US)

(21) Appl. No.: 15/730,072

(22) Filed: Oct. 11, 2017

(51) Int. Cl. G06F 9/44; G06F 11/34

(52) U.S. Cl. CPC G06F 8/38; G06F 9/4443; G06F 11/3438

(57) ABSTRACT

Embodiments herein provide a method and a system for rendering a UI of an application installed in an electronic device based on context of usage and persona of a user. Contextual parameters based on application usage and application session are aggregated, which are fed to a context awareness unit to determine a context. The context is determined by an event processor or a machine learning method based on aggregated parameters, user interactions, user navigation, and so on. The embodiments categorize users based on user dominant behavior by machine learning using the determined context and historical user interactions, to develop user persona. Embodiments render UI templates based on the context and user persona.

### TECHNICAL FIELD

The embodiments herein relate to rendering of User Interface (UI) and, more particularly, to methods and systems for rendering a UI based on user context and persona.

### BACKGROUND

There is a phenomenal variety in terms of type and display size of current electronic devices. The requirements of users of the electronic devices also vary. The user experience (UX) can be satisfactory if the User Interface (UI) is convenient to use. As the requirements of different users vary, the UI needs to update according to the requirements of a particular user. There are applications, which are able to adjust the rendering of the UI. There have not been many changes in these applications, which can dynamically adapt the UI with respect to the requirements of the user. In certain situations, the UI rendered to the user may not have been designed to be viewed on the screen of the electronic device used to view the UI.

Considering an example scenario, in which an enterprise application is designed to provide access to enterprise data of an organization. If the users are classified different based on type and role, wherein each type of user can access the enterprise application data only at a certain access level based on the role of the user; then the UI of the enterprise application needs to be designed such that different UIs are rendered at different access levels. The enterprise application data that needs to be displayed is different for different roles.

### BRIEF DESCRIPTION OF THE FIGURES

The embodiments disclosed herein will be better understood from the following detailed description with reference to the drawings, in which:

FIG. 1 depicts the system for rendering a UI on an electronic device, according to embodiments as disclosed herein;

FIG. 2 depicts a process of creating and storing user personas, according to embodiments as disclosed herein;

FIG. 3 depicts an examples of a UI element (widget), according to embodiments as disclosed herein; and

FIG. 4 depicts an example of how the widgets are stored, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for rendering a UI (User Interface) based on user context and persona. The rendering of the UI can be based on factors such as the domain of an application currently being accessed or viewed, the persona of the user at the point in time in which the user is using the application and the context in which the user is using the application.

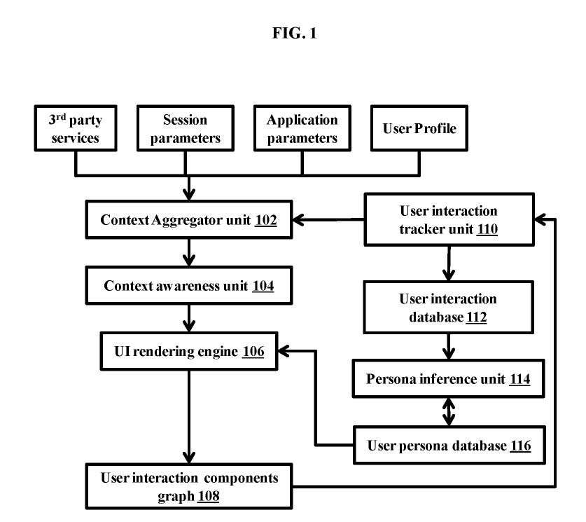

Referring now to the drawings, and more particularly to FIGS. 1 through 5, where similar reference characters denote corresponding features consistently throughout the figures, there are shown embodiments.

FIG. 1 depicts a system for rendering a UI on an electronic device, according to embodiments as disclosed herein. As depicted in FIG. 1, the system can comprise of a context aggregator unit 102, a context awareness unit 104, a UI rendering engine 106, a user interaction components graph 108, a user interactions tracker unit 110, a user interactions database 112, a persona inference unit 114, and a user persona database 116. Considering that a user is using an application installed in the electronic device, the embodiments render a UI, which improves the UX (User Experience).

The context aggregator unit 102 can aggregate parameters from at least one of the sources, such as application parameters, third party parameters such as weather information, user profile information (date of birth, address, and so on), and session parameters (bandwidth of connection, location of user, all the interactions of the user in the session (including navigation pattern, which is provided by the user interaction tracker, device being used, and so on). The contexts can be then provided to the context awareness unit 104.

The context awareness unit 104 determines the context from aggregated contextual parameters, obtained from the context aggregator unit 102. The context awareness unit 104 employs an event processor to determine the known contexts. The event processor can map an event to a context based on prediction performed by machine learning methods. The event processor analyses the stream of information obtained from the aggregated parameters and identifies an event (context) either through correlation of the aggregated parameters, recognizing sequences and patterns of through the application; or using standard event processing techniques. The identified event(s) (contexts) along with the aggregated contextual parameters are fed to a machine learning method to determine further unknown context patterns that may not be identified by the event processor. In an example, the machine learning method can be an association rule, Markov model, decision tree, deep learning, Bayesian networks, and so on.

The determined contexts, obtained from the context awareness unit 104 can be fed to the UI rendering engine 106 to render an UI element. The UI rendering engine 106 can identify or predict a probable user action using the aggregated contextual parameters and the determined contexts. The UI rendering engine 106 determines the part of the application that needs to be rendered to a user. In an embodiment, the UI element can be an element such as a pop-up, widget, tile, and so on.

Embodiments herein can be developed using individual UI components such as widgets. The user interaction components graph 108 can store all the widgets in the application as nodes in a directed graph structure. As part of the graph, the action that underlies the interaction can also be stored. In an example, the click interaction on a button in a UI component may mean initiation of a specific transaction such as money transfer, buying an item, and so on; in the application. The associated action can be stored along with the interaction. Each component can comprise a flag to turn on/off flagging to prevent tracking sensitive information. The user interaction components graph 108 can provide a whole map of the application interaction points.

The user interaction tracker unit 110 can track the interactions of the user with the various UI components/interaction points in the application and store the interactions in the user interactions database 112 along with the user identity and context information. The user interactions database 112 can also store data input provided by the user such as text entered in a text box in a UI component. The module does not track, when the interaction component has its tracking component set to off. The user interaction tracker unit 110 also feeds this information to the context aggregator unit 102.

The persona inference unit 114 can determine the persona of the user in two stages. Though users have different behaviors in different contexts, one behavior might be more dominant than others across contexts. This behavior is identified in the first stage. The persona inference unit 114 can categorize users based on User Dominant Behavior (UDB), using a machine learning algorithm like support vector machine, Naive Bayes method, and so on. The historical interactions of the user with various UI components in user interaction database 112 along with contextual information, determined through context aggregator unit 102, would be used as features by the machine learning algorithm. In the second stage, the persona inference unit 114 can cluster the users into different groups. The clustering can be performed using deep learning neural networks. The clusters can be stored in the user persona database 116 along with the UDBs. The persona determination can be improved over a period of time as user access to the application increases, which in turn increases data availability. The UDB identified in the first stage, the context determined through the context aggregator unit 102 and context awareness unit 104, along with the tracked and stored user interactions, in the user interaction database 112, can become features for a persona learning method. The persona inference module 114 can run asynchronously to the entire application at scheduled intervals.

The UI rendering engine 106 can determine the part of the application that needs to be rendered to the user by predicting forthcoming actions in the application. This can be determined using machine learning tools that obtain context information and persona of the user, determined using the persona inference unit 114 using historical interactions of the user in that context along with other historical interactions of the user in the persona cluster of the user in the same context, to be used as features of the machine learning tools. The machine learning methods can be trained using the historical information of the various users' interactions with the application, at various contexts for the cluster to which the user belongs.

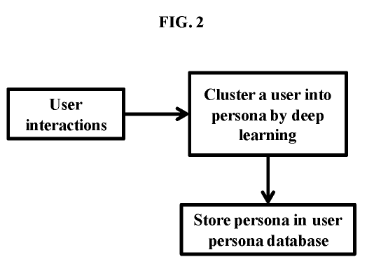

FIG. 2 depicts a process of creating and storing user personas, according to embodiments as disclosed herein. As depicted in FIG. 2, the interactions of a user, obtained from the user interaction database 112, can be used by the persona inference unit 114 for creating the persona of the user. The created persona can be based on the UDB of the user and can be clustered into a group. The clustering can be performed using deep learning. The created user persona can be stored in the user persona database.

The persona inference unit 114 can read the historic user interactions (contexts) from the user interaction database 112, and can use the context information and user interactions and clusters users with similar behavior using deep neural networks as explained earlier. The cluster information can then be stored in the user persona database 116. This can be repeated over a scheduled period in order to increase accuracy of training module, which creates the personas.

Over a period of time, when the clusters are relatively stable, they can be considered as user personas and are studied to observe the behavior of that persona. The UI components/widgets can be thereafter developed for those particular personas. In an example, considering that the application used is in retail domain, the user personas may be ‘casual browser’, ‘gadget freak’ ‘a serious buyer’, and so on. The user personas can be developed based on the UDB, determined contexts (user interactions), and context. The embodiments can develop the persona ‘casual browser’ to cluster users who browses the retail application for products occasionally and buys products rarely. The embodiments can develop the persona ‘gadget freak’ to cluster users who spends much of the session time on electronic gadgets. The embodiments can develop the persona ‘a serious buyer’ to cluster users who exactly searches for the product with its name and usually buys the same, and so on.

The various contexts in which each of these personas can use the application can be ‘small screen size’, low network bandwidth', and so on. The embodiments can determine the context as ‘small screen size’ if the electronic device device used by the user has smaller display window. The embodiments can determine the context as low network bandwidth' if the bandwidth is constrained. The determined contexts affect different user personas in different ways. In an example, a ‘casual browser’ using a ‘small screen’ might not be interested to see the specifications of each and every product, whereas a ‘serious browser’ might be interested in every little detail. Thus each user persona needs to be catered to differently in different contexts. The various templates (views) of each widget can be developed based on the classification of user personas and contexts. Each user persona-context combination can be mapped to a state in a template of each widget. Different persona-context combination can share the same template.

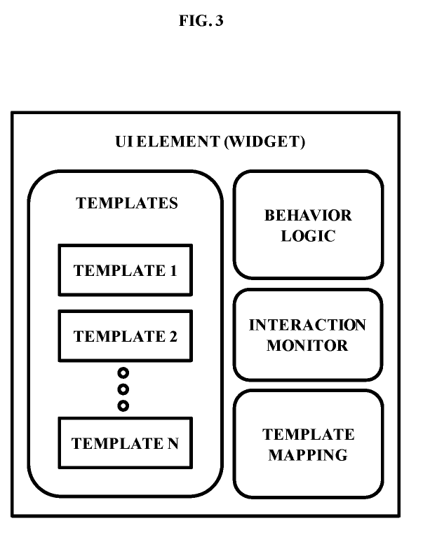

FIG. 3 depicts examples of a UI element (widget), according to embodiments as disclosed herein. The UI element can be a widget, a pop-up, an application component interface, a tile, and so on. As depicted in the example in FIG. 3, the UI element can be a widget. Each widget can have several templates (views), a template-mapping component and behavior logic associated with each template. A template comprises of the view that is to be rendered on the screen. Each template (view) can have different states based on a user persona-context combination. In an example, a long paragraph widget might exhibit only few words initially and when the user clicks on an interaction component labeled ‘more’, it may expand the view to display the complete text. In this example, there are two states, viz., a ‘compressed state’ and an ‘expanded state’. The ‘compressed state’ can be the default state that displays the abridged text and the ‘expanded state’ can be the state, which displays the elongated text.

The behavior logic comprises of logic, which can be used by the templates for rendering the views. The behavior logic can be extended to communicate to third party systems for fetching data for performing some operation or pass on data back to a back-end system. The template-mapping component can comprise of the mapping information of the template to the different contexts, user personas and domains. A domain can represent the broad classification of the application based on the purpose of the application. In an example, the domains can be financial, retail, manufacturing, and so on.

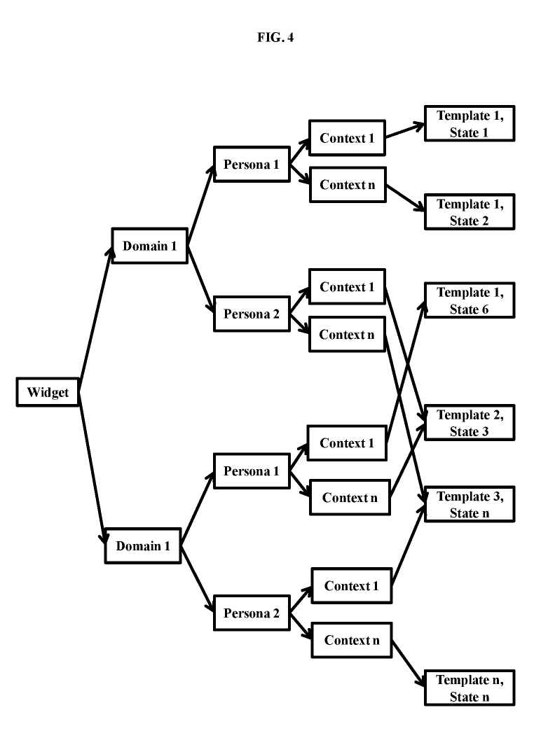

FIG. 4 depicts an example of how the widgets are stored, according to embodiments as disclosed herein. Each widget can be a UI component, which has multiple templates. Each template-state combination can correspond to an interaction behavior and can be mapped to different contexts, which are in turn mapped to personas. Personas can be further classified under a domain. A default configuration can be set in which a generic domain is mapped to a generic user persona, which in turn is mapped to a generic context. A generic context can be mapped to a generic template and a generic template can be mapped to a default template state.

The widgets can be stored in a centralized repository. The repository can contain a dictionary that stores the description regarding each user persona, context and domain. This information can help in development of the widget and the usage of the widget. The repository can also store metadata of each widget such as, name of the widget, description of the widget, explanation of the functionalities of the widget, and so on. The repository can also provide a few functionalities such as, search widget, add widget, update version of widget, delete widget, and so on. The application used by the user can be developed (entirely or in part) as an aggregation of these widgets working in tandem or silos. The widgets can either reside locally in the end device or centrally in the repository and can be accessed by the application running in the electronic device at run time.

The embodiments disclosed herein can be implemented through at least one software program running on at least one hardware device and performing network management functions to control the network elements. The network elements shown in FIG. 1 include blocks, which can be at least one of a hardware device, or a combination of hardware device and software module.

The embodiment disclosed herein specifies systems for rendering a UI based on user context and persona in rendering of UI. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments herein can be practiced with modification within the spirit and scope of the claims as described herein.

We claim:

1. A method of rendering a User Interface (UI) of an application installed in an electronic device, the method comprising:
determining a context of application usage based on at least one aggregated parameter, wherein the aggregated parameters are based on at least one of the installed application and application session;
determining a persona of a user of the application based on the context of application usage and a User Dominant Behavior (UDB), wherein the UDB is based on the context of application usage; and
rendering the UI based on the context, the persona, and a domain of the application.

2. The method, as claimed in claim 1, wherein determining the context of application usage comprises:
identifying a pattern of user navigation through the application by capturing a sequence of user interactions with the application; and
determining a type of the determined context based on the pattern, wherein the type includes one of user preference, a series of actions to obtain a result, and a context created from the determined context.

3. The method, as claimed in claim 2, wherein the method further comprises tracking the pattern and storing the pattern.

4. The method, as claimed in claim 1, wherein the rendering the UI comprises mapping a combination of the context and the persona to generate a template state, wherein the template state constitutes a view of the rendered UI.

5. A system for rendering a User Interface (UI) of an application installed in an electronic device, the system comprising:
a context awareness unit (104) to determine a context of application usage based on at least one aggregated parameter, wherein the aggregated parameters are based on at least one of the installed application and application session, wherein the parameters are aggregated by a context aggregator unit (102);
a persona inference unit (114) to determine a persona of a user of the application based on the context of application usage and a User Dominant Behavior (UDB), wherein the UDB is based on the context of application usage; and
a UI rendering enfine (106) to render the UI based on the context, the context awareness, the persona, and a domain of the application.

6. The system, as claimed in claim 5, wherein determining the context of application usage by the context awareness unit (104) comprises:
identifying a pattern of user navigation through the application by capturing a sequence of user interactions with the application; and
determining a type of the determined context based on the pattern, wherein the type includes one of user preference, a series of actions to obtain a result, and a context created from the determined context.

7. The system, as claimed in claim 6, wherein the system further comprises a user interactions tracker unit (110) to track the pattern and a user interaction database (112) to store the pattern.

8. The system, as claimed in claim 5, wherein the rendering the UI, by the UI rendering unit (106), comprises mapping a combination of the context and the persona to generate a template state, wherein the template state constitutes a view of the rendered UI.
